(19) United States
(12) Patent Application Publication
(10) Pub. No.: US 2012/0055362 A1
(43) Pub. Date: Mar. 8, 2012

(54) DEVICE FOR IDENTIFYING PRINTING PLATES, CORRESPONDING PRINTING PRESS AND METHOD

(75) Inventors: Michel Chretinat, Agnetz (FR); Jean-Francois Rousvoal, Lachelle (FR); Henri Pollet, Vieux-Moulin (FR); Ken Angell, Paris (FR); Wesley William Clements, Durham, NH (US)

(73) Assignee: GOSS INTERNATIONAL MONTATAIRE SA, Montataire (FR)

(21) Appl. No.: 13/100,877

(22) Filed: May 4, 2011

(30) Foreign Application Priority Data
May 4, 2010 (EP) 10305474.8

(51) Int. Cl. B41F 7/02

(52) U.S. Cl. 101/416.1

(57) ABSTRACT

A device for identification of printing plates, including: a support having at least one support place, each support place being adapted to support one (single) printing plate before mounting on a plate cylinder, the or each support place being associated with one (single) location of the printing plate on a plate cylinder, and an identification unit adapted to identify a printing plate supported on the support place.

This application claims priority to European application EP 10305474.8, filed on May 4, 2010, the entire disclosure of which is incorporated by reference herein.

The present invention relates to a device for identifying printing plates for a print job, comprising: support means having at least one support place, each support place being adapted to support one printing plate, in particular one single printing plate; identification means adapted to identify a printing plate supported on the/or each support place.

### BACKGROUND

An identification system for identifying whether the correct printing plate is placed on the correct location of a plate cylinder is for example disclosed in DE103 41 306. This document discloses a system for identifying whether the correct printing plate is associated with a given ink. The system comprises either extrinsic information fixed to the printing plates, as punch coding, bar codes, a data matrix, memory chip, magnet strip and polymeric strip or intrinsic information, as proof areas and labels printed on the printing plate.

The system comprises detectors for detecting whether the correct printing plate and the correct ink are present in the print unit.

However, the system is complicated and expensive, as for each printing plate one detector element is necessary.

Further identification systems are known from EP 941 850, U.S. Pat. No. 6,167,806, JP 5-169638 and JP2004-188642.

Other known press related art include those mentioned below. DE102008002681 relates to a method and apparatus for providing information about printing plates to be manufactured for a new production of a printing press. JP 5169638 relates to a detector for erroneous installation of a printing plate by automatically determining whether a printing plate is installed at a correct position of a printing cylinder or not without depending on the judgment of an operator. EP 1002646 relates to a printing plate mounting position instruction system for instructing users where to mount one or more printing plates in a rotary printing press. JP 60052343 relates to an automatic distributor for a printing plate of a rotary press using a conveyor. U.S. Pat. No. 6,167,806 relates to a control device for controlling the printing of one or more webs of material in a rotary printing press.

### SUMMARY OF THE INVENTION

An object of the present invention is to overcome the drawbacks of the prior art and to create an identification system which is easy to manufacture and economical.

An embodiment of the present invention is an identification system for identifying printing plates for a print job, comprising a support having at least one support place, each support place being adapted to support one printing plate, in particular one single printing plate; an identification unit adapted to identify a printing plate supported on the/or each support place, characterized in that each support place is associated with exactly one location on a plate cylinder, the device for identifying printing plates further comprises an evaluation device adapted to receive information from the identification unit representing an identified printing plate and adapted to evaluate whether the identified printing plate supported on the support place corresponds to a determined printing plate to be carried by the location on the plate cylinder with which the support place is associated.

### BRIEF DESCRIPTION OF THE DRAWINGS

The present invention will be explained in detail with reference to the annexed drawings:

FIG. 1 shows schematically a web-fed offset printing press according to the invention,

FIG. 2 shows an identification system according to a first embodiment of the invention,

FIG. 3 shows an identification system according to a second embodiment of the invention, and

FIG. 4 shows an identification system according to a third embodiment of the invention.

### DETAILED DESCRIPTION

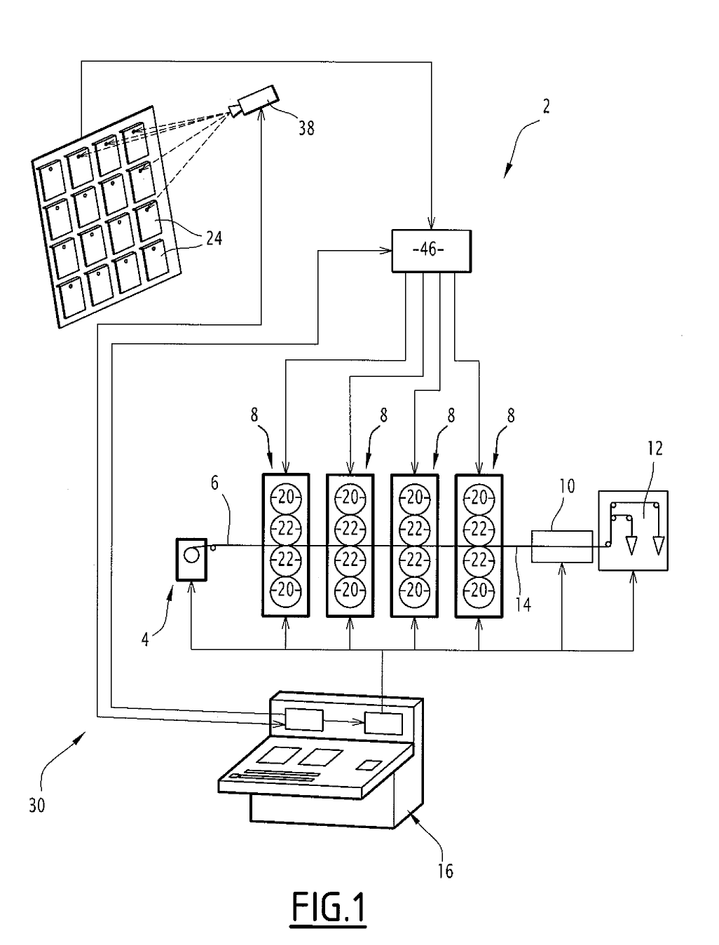

FIG. 1 shows an offset printing press according to the present invention, designated by the general reference 2.

The offset press 2 is for example a web-fed offset press.

Alternatively, the press 2 is not an offset press, but of another press type.

The offset press 2 comprises an unwind unit 4 and an infeed unit 6. The offset press 2 comprises also at least one, and in the present case four, print unit 8. The offset press 2 comprises also a dryer 10 and folder 12. The offset press is adapted to print on a paper web 14 unwound from the unwind unit 4 and running successively through the infeed unit 6, the print unit(s) 8, the dryer 10 and the folder 12.

The offset press 2 comprises a control system 16 controlling the above mentioned components 4, 6, 8, 10 and 12.

Each of the print units 8 comprises at least one plate cylinder 20 and one blanket cylinder 22. The present embodiment comprises two plate cylinders 20 and two blanket cylinders 22 per print unit, each pair of blanket 22 and plate cylinders 20 printing on opposite sides of the web 14.

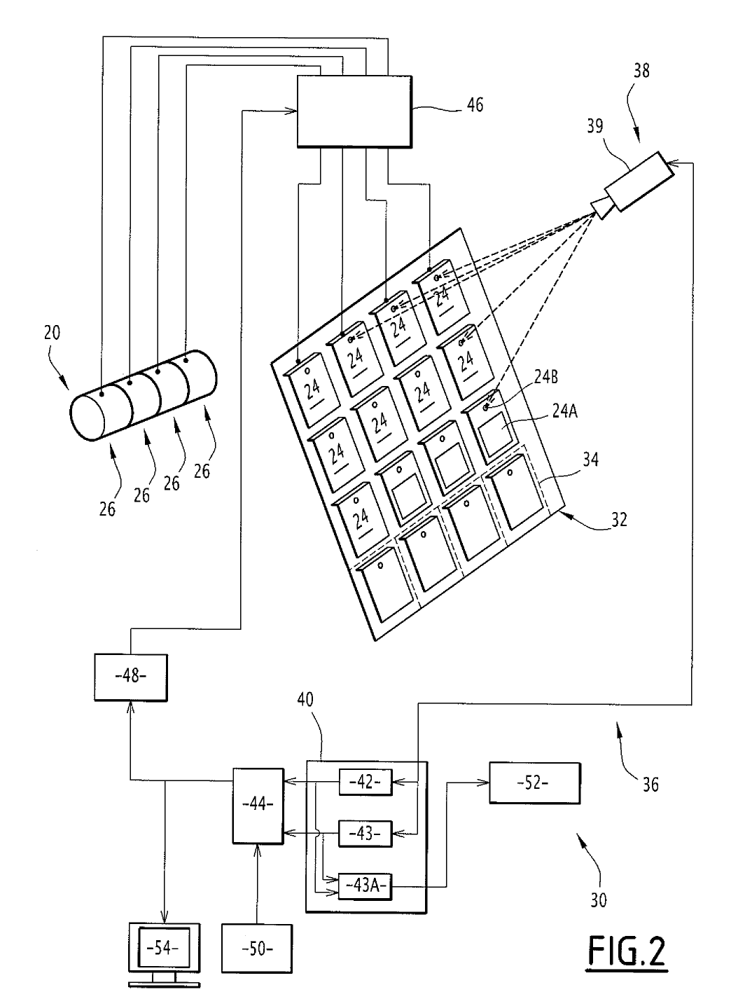

In order to print on the web 14, the printing press comprises at least one printing plate 24, preferably more that one printing plate 24, shown in FIG. 2.

Each plate cylinder 20 has a location 26 for carrying one single printing plate 24. The or each plate cylinder 20 can have more than one location 26 in its axial direction. The or each plate cylinder 20 can have one single (“one around”) or more than one location 26 in its circumferential direction, for example two (“two around”) or four (“four around”). Each printing plate 24 carries for example one single page to be printed of a printed product. The printed product can be a newspaper.

The offset press 2 comprises also a device for identifying printing plates 30.

The device for identifying printing plates 30 comprises support means 32 having one or more support places 34, each support place 34 being adapted to carry one single printing plate 24. Each of the support places 34 is associated with exactly one determined location 26 of a plate cylinder 20. Preferably, the number of support places 34 equals the number of locations 26 on a plate cylinder 20, a print unit 8 or the offset press 2.

The device for identifying printing plates 30 comprises also an identification means 36 adapted to identify a given printing plate 24 supported on a or each support place 34. The identification means 36 comprises, in the example of FIG. 2, a sensor unit 38, in this embodiment a camera 39, and an identification module 40 connected to the sensor unit 38.

The sensor unit 38 is adapted to capture an image of a printing plate 24 or part of a printing plate 24 and to transfer the image to the identification module 40. The identification module 40 has an image recognition module 42 which is adapted to recognize the printing plate 24 based on the transferred image.

To this end, the printing plate 24 carries a printing image 24A of a page to be printed and a code 24B which is distinct from the printing image 24A of the page to be printed. The code 24B is for example a data matrix code or a barcode. The code 24B carries information distinguishing the printing plate 24 from all the other printing plates 24 to be used for a specific print job in the press 2.

The identification means 36, in the present case the identification module 40, comprises also a support recognition means 43 adapted to determine the current support place 34, among a plurality of support places 34, which is inspected by the sensor unit 38. The support recognition means 43 is also adapted to generate a signal representing the current support place 34 of the printing plate 24 currently identified by the sensor unit 38.

To this end, the support recognition means 43 for example receives a signal from the sensor unit 38 indicating the position and/or orientation of the printing plate 24 or the sensor unit 38 with respect to the support means 32.

The device for identifying printing plates 30 comprises also an evaluation means 44 adapted to evaluate whether the printing plate 24 in place at a given support place 34 corresponds to the associated location 26 on the plate cylinder. The evaluation means 44 is adapted to receive information from the identification module 40, or from the image recognition module 42, this information representing the identified printing plate 24. This information is for example transmitted as a signal.

The evaluation means 44 is also adapted to receive the signal representing the current support place 34 from the support recognition means 43.

The evaluation means 44 is adapted to compare the information representing the identified printing plate 24 to information representing the determined printing plate 24 to be mounted on the location 26 associated with the support place 34.

To this end, press 2 has an imposition management system 50. The imposition management system 50 comprises imposition information representing each determined printing plate 24 and the associated print unit 8, the associated plate cylinder 20 and the associated location 26. The imposition management system 50 is connected to the evaluation means 44 and the evaluation means is adapted to receive said imposition information from the imposition management system 50.

The evaluation means 44 is further adapted to generate a signal indicating whether the identified printing plate 24 on support place 34 corresponds to the determined printing plate 24 to be mounted and whether each of the printing plates 24 supported by a respective support place 34 correspond to the associated location 26. This signal is generated as a function of the aforementioned imposition information received from the imposition management system 50.

The press 2 comprises loading means 46 for loading the or each printing plate 24 from each support place 34 to the corresponding location 26 on the plate cylinder and inhibition means 48 for inhibiting the loading means 46 unless the evaluation means 44 has evaluated that each of the printing plates 24 in the support places 34 corresponds to the printing plate associated with the location 26 on the plate cylinder.

To this end, the evaluation means 44 can emit a signal for each printing plate 24 having three statuses: 1. plate not checked—2. plate checked and plate is in the right place—3. plate checked and plate is not in the right place.

These statuses are sent to the inhibition means 48.

The press 2 comprises also a status display 54 which receives status information from the evaluation means 44 and which can display the status for each plate. The status indicated is for example yellow for status number 1, green for status number 2 and red for status number 3. However, other colour codes or status indications can be used.

If the signal representing “plate checked and plate is in the right place” is not present for all of the plates 24, an inhibition signal is generated by the inhibition means 48 and sent to the loading means 46. If the signal “plate checked and plate is in the right place” is present for all of the printing plates 24, a plate loading enable signal is sent to the loading means 46 indicating that the loading means can start loading the plates onto the locations 26. And in case signal “plate checked and plate is not in the right place” is present for each printing plate 24, a plate mounting disable signal is generated.

The press 2 comprises also a prepress control unit 52.

The identification means 36, and in particular the identification module 40, are further adapted to generate a signal indicating the position of each of the checked printing plates 24 on the support places 34. This signal is for example sent to the prepress control unit 52. The prepress control unit 52 can then for example indicate the position of each printing plate 24 on a display unit. To this end, the identification module 40 comprises an interface module 43A adapted to receive information from the image recognition module 42 and from the support recognition means 43. The interface module 43A is adapted to generate the signal indicating the position of each of the checked printing plates 24 on the support places 34 and send it to the prepress control unit 52. However, the module 43A is optional and can be omitted.

The preparation of the offset press 2 for a given print job has the following successive steps.

a) All the printing plates 24 of the print job are put onto their respective corresponding support place 34.

b) The sensor unit 38 captures an image of one single printing plate 24 and sends the image to the identification module 40 which, for example using the image recognition module 42, identifies the printing plate 24.

c) A signal is generated indicating the current support place 34 of the printing plate 24. This signal is for example generated by the support recognition means 43 based on a known position, orientation and/or visual field of the sensor unit 38 and a known position of each of the support places 34.

d) Based on the signal indicating the current support place 34 and the identified printing plate 24, a signal is generated indicating whether the current identified printing plate 24 corresponds to the location 26 associated with the support place 34, in particular using the information from the imposition management system 50.

These steps b) to d) are repeated for each of the printing plates 24.

e) In case all of the printing plates 24 in the support places 34 correspond to the corresponding locations 26, the evaluation means 44 generate the plate mounting enable signal.

f) In reply to the plate mounting enable signal, the plate loading device 46 loads then the plates 24 from the support places 34 to the corresponding locations 26 on the plate cylinders 20.

The device according to the invention has the following advantages:

No visual code is necessary on the support places 34 for their identification, the identification of the support place being based on one or more of the visual information, such as view field, and the orientation of the sensor unit 38.

Only one sensor unit 38 is used to identify more than one printing plate 24 and in particular more than one printing plate 24 belonging to two different plate cylinders or print units. The device is therefore inexpensive and simple.

Alternatively, the sensor unit 38 can also capture an image of two or more printing plates 24 simultaneously. The identification means are then able to select the code 24B of the print plate 24 to be identified among the codes of the printing plates on the captured image.

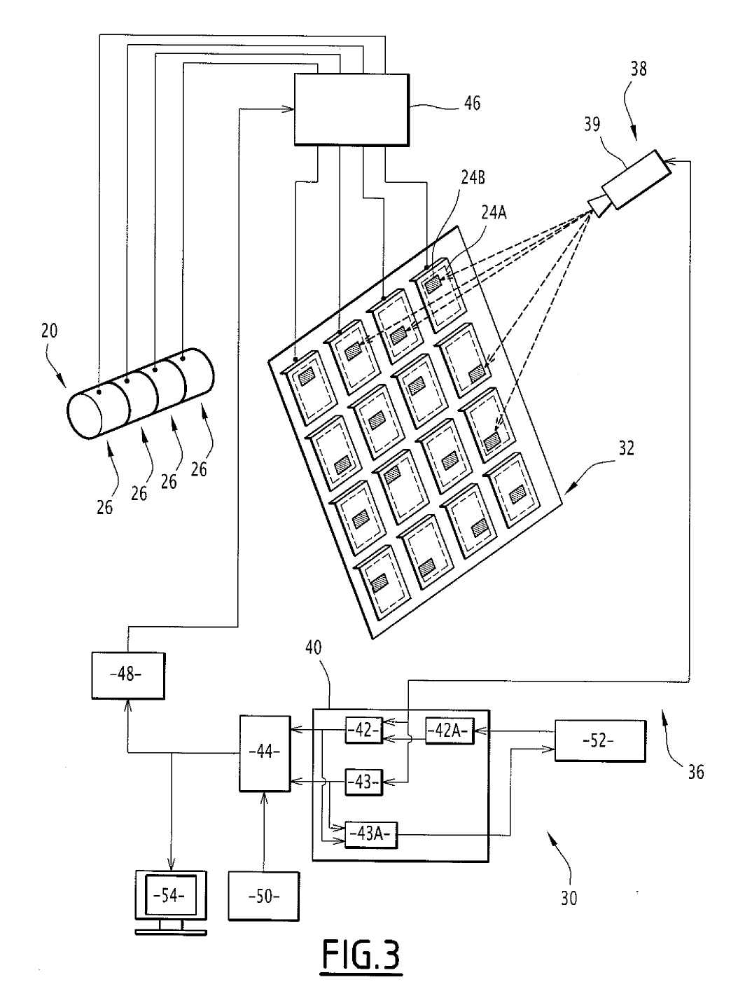

FIG. 3 shows schematically a device for identifying printing plates 30 according to a second embodiment of the invention. Only the differences with respect to the first embodiment are indicated. Similar elements carry the same reference number.

The printing plates 24 do not carry a code 24B distinct from the image 24A to be printed. Instead, the code is a discrimination zone 24B which is part of the image 24A to be printed.

The discrimination zone 24B of each of the printing plates 24 can be placed at different places of the printing plate and is not necessarily at the same place for each of the printing plates 24 of one print job.

The discrimination zone 24B is defined by its place on the plate 24, its size, its orientation and its content.

To this end, the identification means 36 has a memory 42A in which at least the discrimination zone 24B of the printing plate 24 currently to be checked is stored, and preferably all the discrimination zones 24B of the print job to be prepared.

In the present embodiment, the memory is implemented as memory 42A which is connected to the image recognition module 42.

The use of the discrimination zone 24B is advantageous as the information for identifying the printing plate is on the printed image and does not reduce the available size of the page to be printed.

Also, the information for identifying the printing plate is inherent in the picture to be printed and no code needs to be created, thus saving procedural steps.

The discrimination zone 24B of all of the plates 24 of a print job is generated by the prepress control unit 52 which has information of all of the images 24A. The prepress control unit selects in each of the plates a discrimination zone 24B which is not comprised in any of the other images. Then the prepress control unit 52 sends the discrimination zone 24B of one or each of the plates 24 to memory 42A.

The general steps of preparing the print job are in this case:

a) generating a discrimination zone 24B for each of the printing plates of one given print job, the discrimination zone 24B of each printing plate differing from the discrimination zones 24B of all the other printing plates of the print job and uniquely identifying the printing plate 24;

b) putting all the printing plates 24 of one print job onto the corresponding support place;

c) for each printing plate: capturing an image of the discrimination zone 24B of one printing plate and identifying the printing plate based on the captured image and verifying whether the identified printing plate 24 corresponds to the printing plate associated with the location 26 to which its support place 34 corresponds;

d) starting the print job and/or loading the printing plates to the locations 26 only in case each of the printing plates is in the support place associated with the location 26 onto which the printing plate has to be placed.

The embodiments of FIGS. 1 to 3, have support places 34 supporting the printing plates 24 before mounting on a plate cylinder.

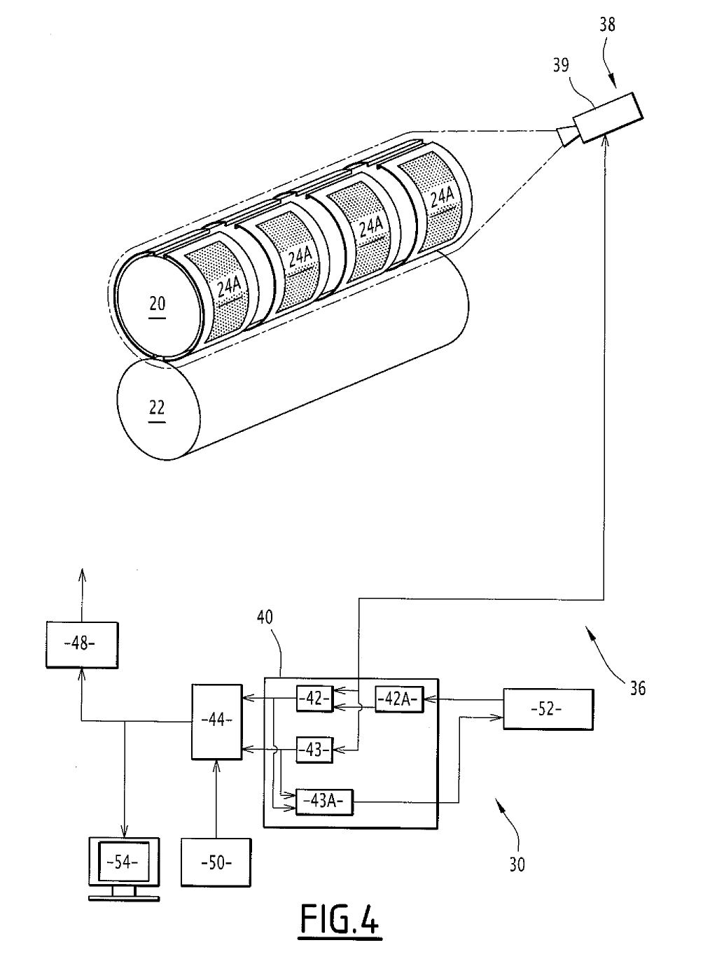

On FIG. 4, a third embodiment of the invention is shown. Only the differences with the first and second embodiments are mentioned. In this embodiment, as a difference to the aforementioned embodiments, the support places are the locations of the printing plate 24 on the plate cylinder.

In this case, the identification means 36 is adapted to identify a printing plate 24 arranged on a location 26 of a plate cylinder 20, and the evaluation means 44 are adapted to evaluate whether the printing plate 24 is in the correct location 26.

Also, the inhibition means 48 does not inhibit plate loading means 46, but inhibits the start of the print job on the press. To this end, the inhibition means 48 is adapted to send a press start inhibition signal to the control system 16.

In this embodiment, the identification means 36 comprises control means for driving the plate cylinder 20 in a rotational position, in which the sensor unit 38 is able to sense the identification information on the printing plate. More particularly, the identification means comprises means for evaluating whether the code 24B or the discrimination zone 24B is in a position in which it can be captured by the sensor unit. In case this evaluation is negative, these evaluating means are able to emit a signal to the control system 16 driving the corresponding print cylinder to a rotational position in which the zone or code 24B can be captured by the sensor unit 38.

According to other embodiments, the identification means comprises a mobile sensor unit, for example a scanner, in particular a barcode scanner, and means for determining the current position of the mobile identification module with respect to the support place. These means for determining can for example comprise proximity sensor means such as an RFID tag and associated RFID sensing unit. The means for determining the current position can also be implemented using means by triangulation.

Other features of the invention are:

The support means 32 are part of an automatic plate loading system, the plate loading means transferring the plates onto the plate cylinder from the support means.

In case the support places 34 are the locations 26 on the plate cylinder 20, the device for identifying printing plates 30 is adapted to turn the plate cylinder 20 until the code 24B or the discrimination zone 24B is visible to the sensor unit 38.

The device for identifying printing plates 30 is adapted to generate a press start disable signal, unless the evaluation means 44 have checked that each printing plate 24 present on a support place 34 corresponds to the associated location 26 on the plate cylinder.

The device comprises one sensor unit 38 per plate cylinder 20 and/or per print unit 8.

The sensor unit 38 is orientable in two axes in order to examine all plates on the support means.

The press comprises means for generating information representing a discrimination zone 24B for each of the printing plates 24 identifying uniquely each plate 24 for a given print job.

The image recognition module 42 can be replaced by image recognition means.

It is to be understood that each and every one of the different features of the printing press explained above with respect to the different embodiments can be dissociated one from another and does not need to be necessarily implemented in combination even if they are disclosed hereabove in combination. They can be implemented in all technically possible combinations.

What is claimed is:

1-15. (canceled)

16. A device for identifying printing plates for a print job, the device comprising:
a support having at least one support place, each support place being adapted to support one printing plate;
an identification unit adapted to identify the printing plate supported on the/or each support place, wherein each support place is associated with exactly one location on a plate cylinder; and
an evaluation device adapted to receive information from the identification unit representing an identified printing plate and adapted to evaluate whether the identified printing plate supported on the support place corresponds to a determined printing plate to be carried by the location on the plate cylinder with which the support place is associated.

17. The device as recited in claim 16 wherein the or each support place is adapted to support the printing plate before mounting the printing plate on the plate cylinder, the or each support place being associated with the one location of the printing plate on the plate cylinder.

18. The device as recited in claim 16 wherein the support place is the one location on the plate cylinder for carrying the printing plate.

19. The device as recited in claim 16 wherein the identification unit comprises a sensor unit adapted to sense identification information on the printing plate.

20. The device as recited in claim 19 wherein the identification unit further comprises a control unit for driving the plate cylinder in a rotational position, wherein the sensor unit is able to sense the identification information.

21. The device as recited in claim 20 wherein the sensor unit is mobile with respect to the support and the identification unit, the identification unit further comprising a support recognition device adapted to determine a current support place inspected by the sensor unit and to generate a signal representing the current support place.

22. The device as recited in claim 21 wherein the support recognition device further comprises a determination unit for determining the current position and/or an orientation of the sensor unit with respect to the support.

23. The device as recited in claim 21 wherein the sensor unit comprises a camera, and the identification unit further comprises an image recognition device recognizing an image captured by the camera.

24. The device as recited in claim 22 wherein the determination unit for determining the current position comprises a detector detecting the current position by triangulation or a proximity detector.

25. The device as recited in claim 23 wherein the image recognition device is adapted to recognize a code on the printing plate, the code being distinct from the image to be printed.

26. The device as recited in claim 23 wherein the image recognition device is adapted to recognize at least a discrimination zone of the image to be printed and identify the printing plate based on the discrimination zone.

27. The device as recited in claim 16 wherein the support comprises at least two support places, each support place adapted to support one printing plate.

28. A printing press comprising:
a plate cylinder having at least one location for a printing plate; and
a device for identifying printing plates according to claim 16, the at least one print location of the plate cylinder being the associated location.

29. The press as recited in claim 28 further comprising a loading device for loading the or each printing plate from the support place to a corresponding location on the plate cylinder and an inhibitor for inhibiting the loading device unless an evaluation device has evaluated each of the printing plates corresponds to the corresponding associated location on the plate cylinder.

30. The press as recited in claim 28 wherein the printing plate comprises identification information adapted to be identified by the identification unit.

31. A method of preparing a print job on a print unit as recited in claim 28, the method comprising the successive steps of:
loading at least one printing plate on a support place, the or each support place being associated with one determined location of the printing plate on a plate cylinder;
identifying the printing plate on the support place;
evaluating whether the printing plate in place at the support place corresponds to the associated location on the plate cylinder; and
starting the print job only if each printing plate in place at the support place corresponds to the associated location on the plate cylinder.

32. The device as recited in claim 16 wherein the one printing plate is a single printing plate.

33. The device as recited in claim 17 wherein the one location is a single location.

34. The device as recited in claim 24 wherein the proximity detector is radio frequency identification sensor.

35. The device as recited in claim 24 wherein the code is a data matrix code or a barcode.

36. The printing press as recited in claim 27 wherein the printing press is a web-fed offset printing press.
